(19) United States
(12) Patent Application Publication
(10) Pub. No.: US 2012/0066419 A1
(43) Pub. Date: Mar. 15, 2012

(54) TERMINAL HAVING CONTENT INTERWORKING FUNCTION AND METHOD THEREOF

(75) Inventors: Sung Woo PARK, Seoul (KR); Geum Dan JIN, Seoul (KR)

(73) Assignees: KIA MOTORS CORPORATION, Seoul (KR); HYUNDAI MOTOR COMPANY, Seoul (KR)

(21) Appl. No.: 12/951,887

(22) Filed: Nov. 22, 2010

(30) Foreign Application Priority Data
Sep. 13, 2010 (KR) 10-2010-0089437

(51) Int. Cl. G06F 13/10

(52) U.S. Cl. 710/62

(57) ABSTRACT

A terminal having a content interworking function and a method thereof are provided, in which a specific content is executed in a first terminal, an execution information of the specific content is transmitted to a second terminal to be displayed through the second terminal, and an event generation signal corresponding to the execution information of the specific content displayed on the second terminal is collected by the first terminal to control an execution operation of the specific content.

### CROSS-REFERENCES TO RELATED APPLICATIONS

This application claims under 35 U.S.C. §119(a) the benefit of Korean Patent Application No. 10-2010-0089437, filed on Sep. 13, 2010, which is incorporated by reference in its entirety.

### BACKGROUND OF THE INVENTION

1. Field of the Invention

The present invention relates to a terminal having a content interworking function that allows a content to be communicated with another terminal and a method thereof.

2. Description of the Related Art

FIG. 1 is a schematic diagram illustrating the configuration of a conventional content interworking network.

A head unit that is typically installed in a vehicle to operate various multimedia contents shares a content with a mobile terminal such as a smartphone or a music play terminal by connecting to the mobile terminal via, for example, a USB cable. Conventionally, the head unit and the mobile terminal respectively include a database for storing contents, a decoder for decoding the contents, a program execution module that includes application programs for executing the decoded contents, a communication module for transmitting data to an external device connected thereto, and a display module for outputting the executed contents. When the head unit and the mobile terminal are connected to each other, one of the head unit and the mobile terminal serves as a server to display the contents while the other serves as a client to provide the contents to the server, decode and perform data processing and execute the contents. Thus, since one of the head unit and the mobile terminal is required only to function as a display device, the database and the execution module become unnecessary in such a terminal.

Therefore, when two terminals are coupled to each other in such a manner that a first terminal stores and executes a specific content while a second terminal merely displays execution information of the specific content being executed, it is possible to delete elements that are irrelevant to a display function in the first terminal and, accordingly, it is necessary to develop such s technique.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in view of the above problems, and provides a terminal having a content interworking function and a method thereof in which a specific content is executed in a first terminal, an execution information of the specific content is transmitted to and displayed on a second terminal that is interlinked with the first terminal, and an event generation signal, which is associated with the execution information of the specific content being displayed by the second terminal, is collected by the first terminal to control an execution operation of the specific content.

An aspect of the present invention provides a terminal having a content interworking function, which includes an execution module configured to execute a specific content to generate an execution information of the specific content; a communication module configured to interwork with an external terminal to communicate a data therewith; and a control module configured to transmit the execution information of the specific content to the external terminal such that the execution information of the specific content is displayed on a display module of the external terminal, wherein the control module receives from the external terminal an event generation signal indicating a content of an event corresponding to the execution information of the specific content, the event being generated by a key input module of the external terminal.

Another aspect of the present invention provides a method of interworking a content in a terminal, the method includes (a) generating an execution information of a specific content by executing the specific content; (b) transmitting the execution information of the specific content to an interlinked external terminal to display the execution information of the specific content on a display module of the external terminal; and (c) controlling an execution operation of the specific content based on an event generation signal received from the external terminal, the event generation signal indicating a content of an event generated through a key input module of the external terminal.

In the terminal having the content interworking function according to the present invention, the execution information of the specific content is transmitted to the external terminal so that the external terminal displays the execution information of the specific content through the display module of the external terminal and receives the event generation signal associated with the execution information of the specific content. Therefore, the external terminal may interwork with the terminal to display information of the content without requiring the external terminal to have an execution module to execute the content.

### BRIEF DESCRIPTION OF THE DRAWINGS

The objects, features and advantages of the present invention will be more apparent from the following detailed description in conjunction with the accompanying drawings, in which:

FIG. 1 is a schematic diagram illustrating a configuration of a conventional content interworking network;

FIG. 2 is a block diagram illustrating the configuration of a content interworking network according to the present invention;

FIG. 3 is a block diagram illustrating the configuration of a first terminal in a content interworking network according to the present invention;

FIG. 4 is a block diagram illustrating the configuration of a second terminal in a content interworking network according to the present invention;

FIG. 5 is a block diagram illustrating the configuration of a third terminal in a content interworking network according to the present invention;

FIG. 6 is a flowchart illustrating a method of interworking a content according to the present invention; and

FIGS. 7 to 17 are schematic diagrams illustrating exemplary applications of a content interworking network according to the present invention.

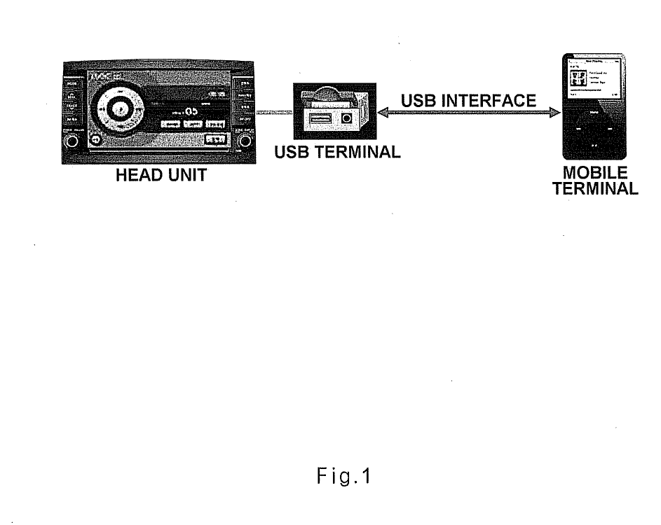

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

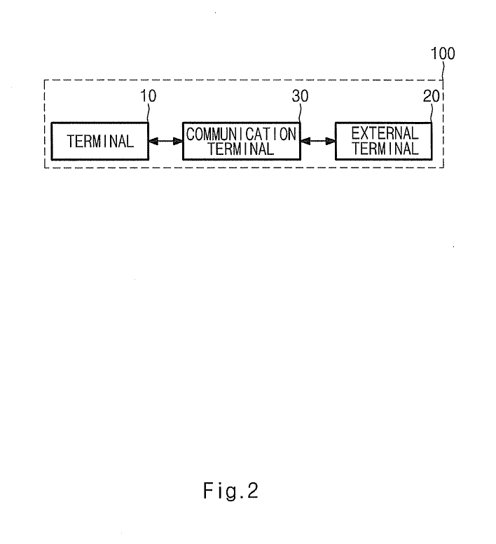

FIG. 2 is a block diagram illustrating the configuration of a content interworking network according to the present invention.

A content interworking network 100 according to an exemplary embodiment of the present invention includes a terminal 10, an external terminal 20, and a connection terminal 30.

The terminal 10 decodes and executes a specific content to generate execution information of the specific content. The terminal 10 transmits the generated execution information of the specific content to the external terminal 20 so that the external terminal 20 displays the execution information of the specific content through a display module 22 of the external terminal 20. The terminal 10 receives an event generation signal from the external terminal 20, wherein the event generation signal indicates a content of an event that is generated by the external terminal 20 in association with the execution information of the specific content. The terminal 10 controls an execution operation of the specific content by using the received event generation signal.

The external terminal 20 displays the execution information of the specific content received from the terminal 10. When the event is generated through a key input module 23 during a display of the execution information of the specific content, the external terminal 20 generates the event generation signal indicating the content of the event and transmits the event generation signal to the terminal 10.

The connection terminal 30 relays a data communication between the terminal 10 and the external terminal 20.

Hereinafter, elements of the content interworking network 100 according to the present invention will be described in details.

In the following description, for explanatory purposes, it is assumed that that a first terminal 10 is a terminal that decodes, performs data processing and executes the specific content to transmit the execution information of the executed specific content to the external terminal. Also, it is assumed that a second terminal 20 is the external terminal that displays the execution information of the executed specific content received from the first terminal 10. Here, the first terminal 10 may be a multimedia terminal of a vehicle and the second terminal 20 may be a mobile communication terminal, a computer or a service providing server. Alternatively, the first terminal 10 may be the mobile communication terminal, the computer or the service providing server and the second terminal 20 may be the multimedia terminal of the vehicle.

First Terminal 10

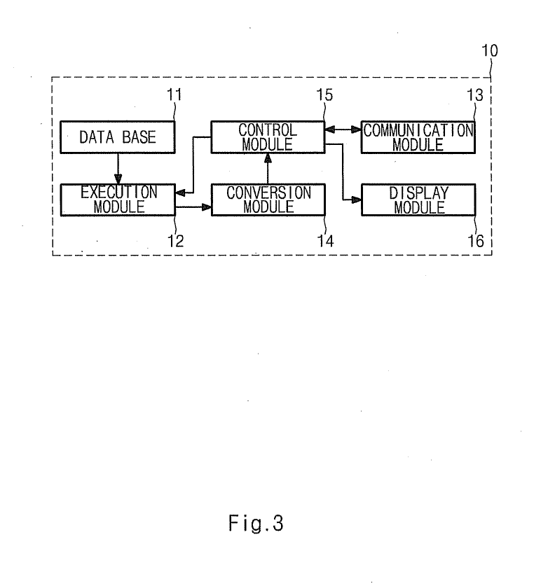

FIG. 3 is a block diagram illustrating an example of the configuration of the first terminal 10 in the content interworking network 100 according to the present invention.

As described above, the first terminal 10 decodes, performs data processing, executes the specific content and transmits the execution information of the specific content to the second terminal 20.

The terminal 10 includes a database 11, an execution module 12, a communication module 13, a conversion module 14, a control module 15, and a display module 16.

The database 11 stores contents including a vehicle information data, a vehicle diagnostic data, a multimedia file, a navigation program, an email program, a telephone calling program, an electronic map, a game, a web browser program and various traffic information.

The execution module 12 includes a decoder for decoding the specific content and an application program that executes the specific content. The execution module 12 generates the execution information of the specific content by executing a content(s) stored in the database. Here, the execution information of the specific content indicates image and voice information, which is generated by executing the specific content and displayed by the display module 16 of the second terminal 20, which will be further described below.

The communication module 13 is interlinked with the second terminal 20 by using a pre-defined communication protocol to communicate data. The communication module 13 may use a wire communication module such as USB, HDMI, AUX or a wireless communication module such as WIFI, WIBRO or a mobile communication module. Here, the communication module 13, when connected with the second terminal 20, identifies device information of the second terminal 20, which includes a resolution of the display module 16 of the second terminal 20 through a known device identification process.

The conversion module 14 converts the execution information of the specific content executed by the execution module 12 to comply with the resolution of the display module 16 of the second terminal 20 or instrument performance (CPU, graphics card, etc.) by using device information of the display module 16 of the second terminal 20.

The control module 15 transmits to the second terminal 20 the execution information of the specific content of which resolution is changed by the conversion module 14 so that the second terminal 20 displays the execution information of the specific content through the display module 22 of the second terminal 20.

Meanwhile, the control module 15 receives an event generation signal, which is generated by the key input module 23, from the second terminal 20, wherein the event generation signal indicates a content of an event that is associated with the execution information of the specific content. For example, when the control module 15 of the first terminal 10 transmits to the second terminal 20 execution information associated with an address of a specific web site (e.g., http://www.naver.com), the execution information associated with the address of the specific web site, namely, a web page of http://www.naver.com is displayed on the display module 22 of the second terminal 20. Next, when an event is generated by a user of the second terminal 20 by clicking a particular character or a particular image on the web page of http://www.naver.com through the key input module 23 such as, for example, a touch screen that is linked with the display module 22, the event generation signal indicating a content of the event is generated by a control module 24 of the second terminal 20.

Here, the content of the event may include information about a particular character being selected, information about a particular image being selected, a screen scroll signal or an input signal of a particular text. For example, if an event of the user of the second terminal 20 clicking a phrase “[TV] This is what Apple TV is about, Steve Jobs PT-site” on the web page of http://www.naver.com, the control module 24 of the second terminal 20 may provide a link address “http://www.inews24.com/?021421” that corresponds to the above phrase on the web page as the event generation signal that is associated with the event. In another example, the control module 24 of the second terminal 20 may transmit to the first terminal 10 a coordinate value of a word clicked by the user of the second terminal 20 and device information including a resolution of the display module 22 of the second terminal 20. In this case, the second terminal 20 of the control module 24 converts the coordinate value of the word being touched to a coordinate value on the display module 16 of the first terminal 10 by using the coordinate value on the first terminal 10 and the device information, and transmits the converted coordinate value to the first terminal 10.

Here, the event generation signal associated with the screen scroll signal may be generated based on information regarding a change in the coordinate value of an object being touched. Accordingly, a content of an event that is same with the event generated by the key input module 23 of the second terminal 20 applies to the first terminal 10 so that an execution operation of the specific content (e.g., a display operation associated with a particular character or image being clicked) performed by the execution module 12 of the first terminal 10 may be controlled through the key input module 23 of the second terminal 20.

The display module 16 displays the execution information of the specific content executed by the execution module 12. Because the control module 15 of the first terminal 10 transmits the execution information of the specific content to the second terminal 20, the display module 16 of the first terminal 10 displays the same screen as the display module 22 of the second terminal 20.

Second Terminal 20

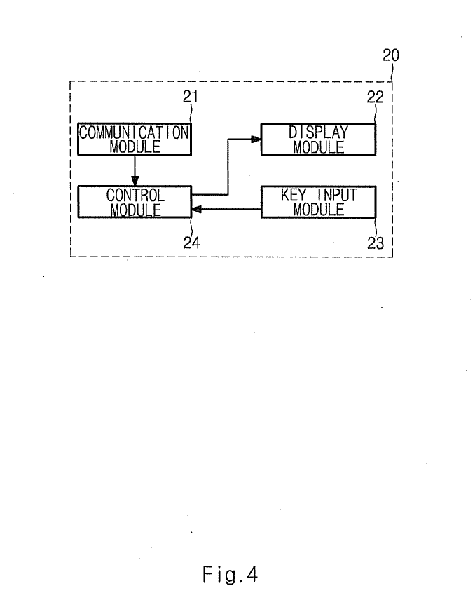

FIG. 4 is a block diagram illustrating an example of the configuration of the second terminal 20 in the content interworking network 100 according to the present invention.

As described above, the second terminal 20 displays the execution information of the specific content received from the first terminal 10 and transmits to the first terminal 10 a content of an event corresponding to the execution information of the specific content.

The second terminal 20 includes a communication module 21, the display module 22, the key input module 23, and the control module 24.

The communication module 21 receives from the first terminal 10 the execution information of the specific content executed by the first terminal 10.

The display module 22 displays the execution information of the specific content.

The key input module 23 receives a key input signal from the user. Here, the key input module 23 includes a key pad that allows a character input or a touch screen that interworks with the display module.

When an event is generated through the key input module 23 while the execution information of the specific content is displayed on the display module 22, the control module 24 transmits the event generation signal indicating the content of the event to the second terminal 20. The event generation signal is discussed above, and thus a detailed description thereof will be omitted.

Connection Terminal 30

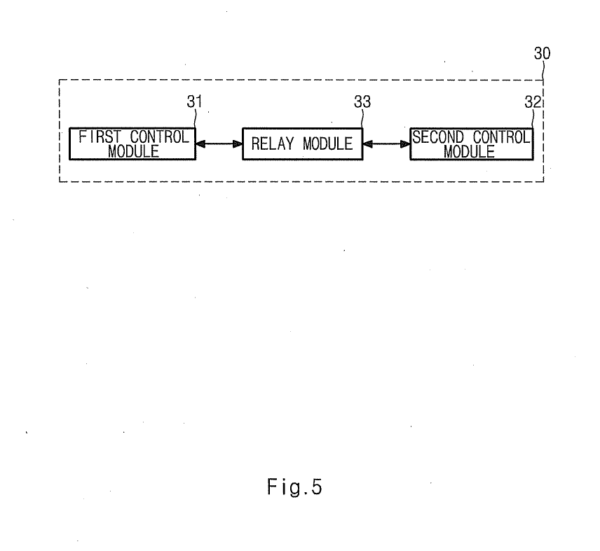

FIG. 5 is a block diagram illustrating an example of the configuration of the connection terminal 30 in the content interworking network 100 according to the present invention.

The connection terminal 30 is used to relay the data communication between the first terminal 10 and the second terminal 20. The connection terminal 30 includes a first communication module 31, a second telecommunication module 32, and a relay module 33.

The first communication module 31 is wired or wirelessly connected with the communication module 13 of the first terminal 10 via a pre-defined protocol to communicate data with the first terminal 10.

The second communication modules 32 is wired or wirelessly connected to the communication module 21 of the second terminal 20 via a pre-defined protocol to communicate data with the second terminal 20. Here, if the second terminal 20 is a service providing server and the second communication module 32 is a long distance wireless communication module such as the WIBRO, the first terminal 10 may remotely transmit and receive data with the service providing server.

The relay module 33 transmits the execution information of the specific content received from the first terminal 10 to the second terminal 20 and transmits to the first terminal 10 the event generation signal indicating the content of the event corresponding to the execution information of the specific content received from the second terminal 20.

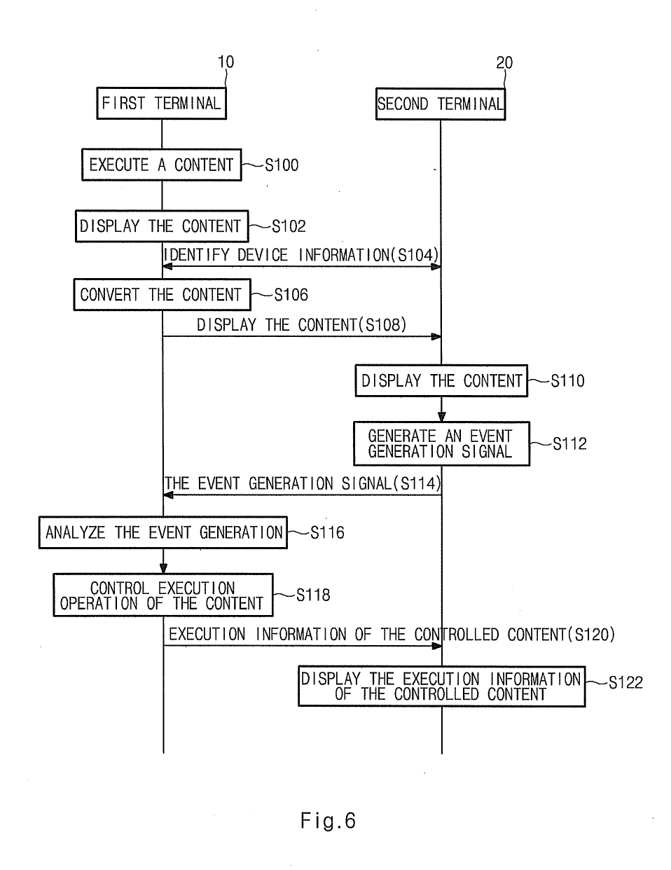

With reference to FIG. 6, a method of interworking a content according to an embodiment of the present invention will be described below.

First, the execution module 12 of the first terminal 10 executes the specific content stored in the database 11 to generate the execution information of the specific content (S100).

Next, the display module 16 of the first terminal 10 displays the execution information of the specific content (S102).

Then, the communication module 13 of the first terminal 10 identifies device information of the second terminal 20 when connected with the second terminal 20 (S104).

The conversion module 14 of the first terminal 10 converts the generated execution information of the specific content in correspondence with the device information of the second terminal 20 (S106).

The control module 15 of the first terminal 10 transmits the execution information of the specific content converted by the communication module 13 to the second terminal 20 (S108).

The control module 24 of the second terminal 20 displays the execution information of the specific content received through the communication module 21 by using the display module 22 (S110).

Then, when an event is generated by a user while the execution information of the specific content is displayed on the display module 22, the key input module 23 of the second terminal 20 generates the event generation signal indicating the content of the generated event (S112) and transmits the event generation signal to the first terminal 10 (S114).

Next, the control module 15 of the first terminal 10 analyzes the content of the corresponding event and transmits an analysis result to the execution module 12 (S116).

The execution module 12 of the first terminal 10 controls an execution operation of the specific content based on the analysis result (S118) and transmits to the second terminal 20 the execution information of the specific content in accordance with the controlled execution operation (S120).

The control module 24 of the second terminal 20 displays the execution information of the specific content according to the controlled execution operation through the display module 22 (S122).

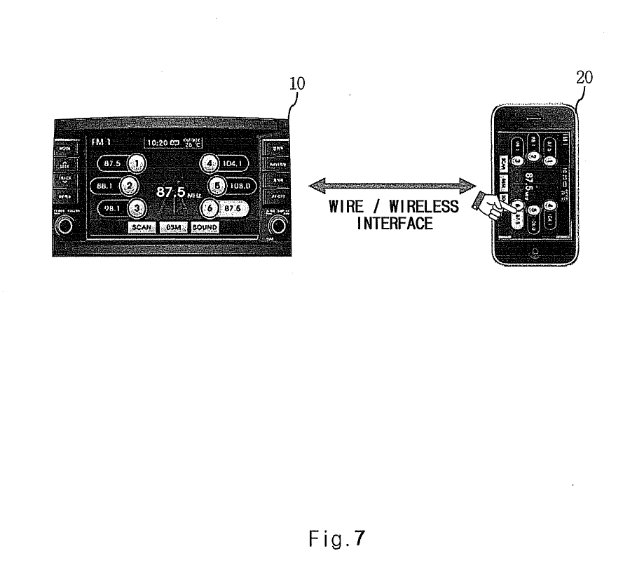

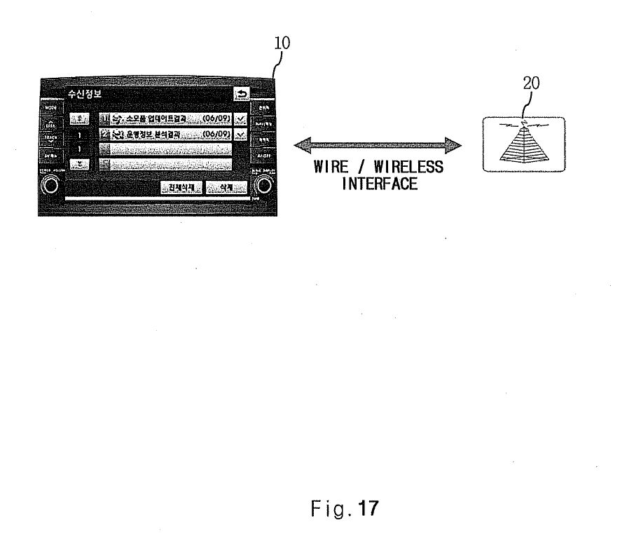

Referring to FIGS. 7 to 17, exemplary applications of content interworking network 100 according to the present invention will be described.

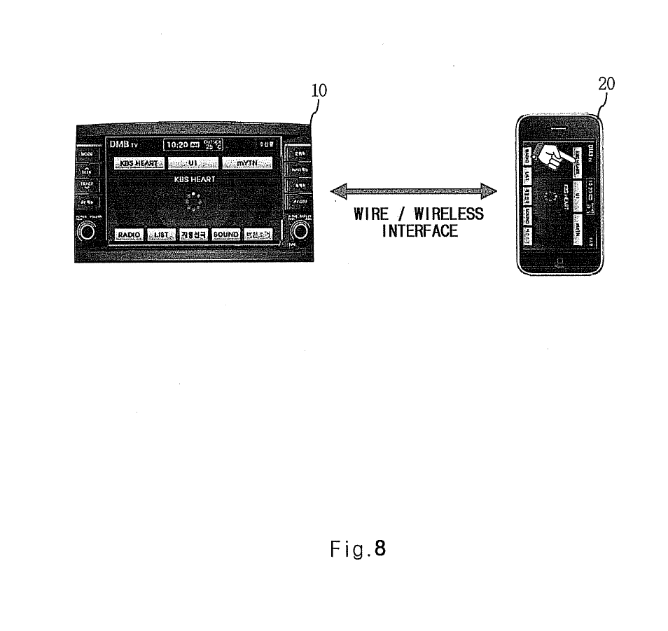

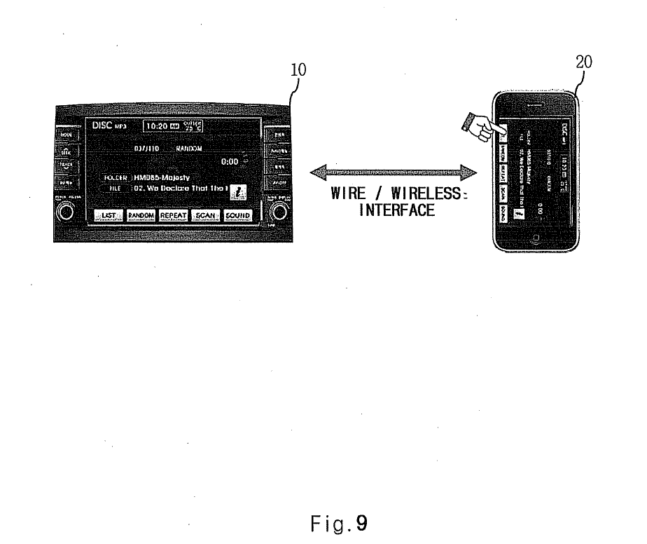

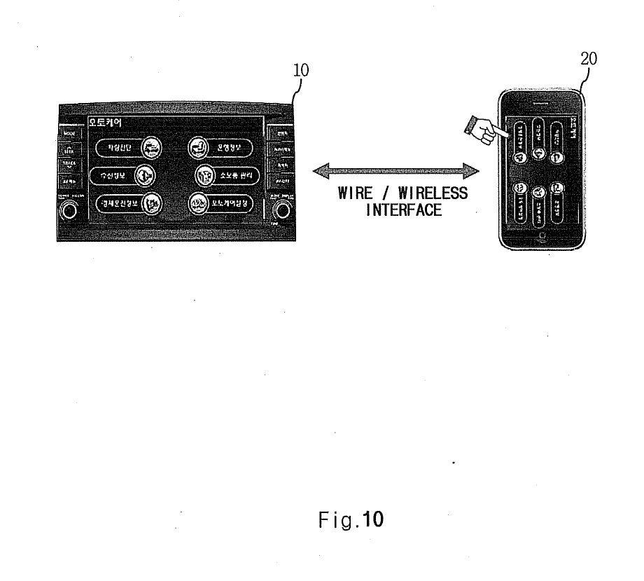

In an example, the first terminal 10 can be a head unit of a vehicle and the second terminal 20 can be a mobile communication terminal, the first terminal 10 operates a radio receiving program (see FIG. 7), a digital multimedia broadcasting (DMB) receiving program (see FIG. 8), a music playing program (see FIG. 9) and a vehicle diagnostic program (see FIG. 10) and transmits to the second terminal 20 the execution information (screen) of the radio receiving program, the execution information (screen) of the DMB receiving program, the execution information (screen) of the music playing program, the execution information (screen) of the vehicle diagnostic program. The second terminal 20 displays the execution information through the display module 22. Here, for example, if an event occurs in which a user selects a specific channel by clicking a character or an image while the radio receiving program is executed, the second terminal 20 generates the event generation signal based on the content of the event and transmits the event generation signal to the first terminal 10. Then the first terminal 10 analyzes the event generation signal and transmits an analysis result to the execution module 12 so that the execution module 12 executes the content of the event according to the event generation signal, i.e., selects and executes the specific channel and transmits the execution information of the specific channel that is executed to the second terminal 20.

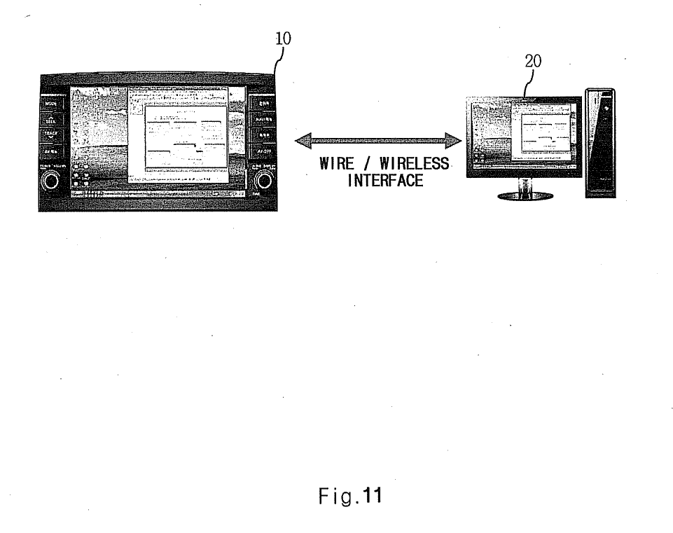

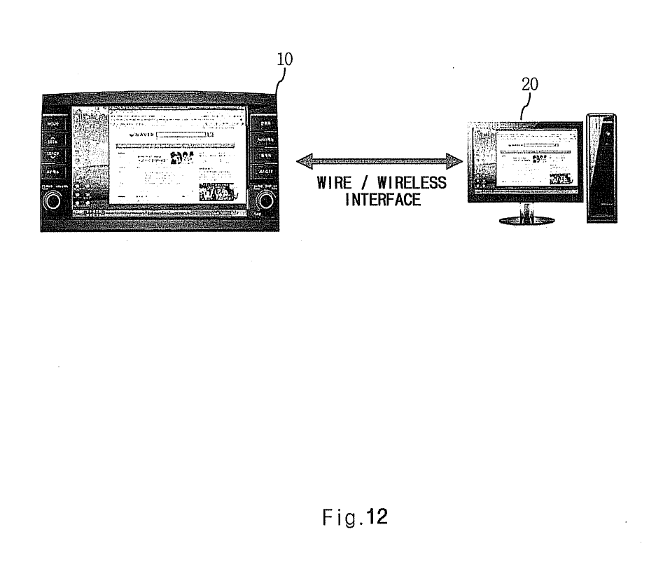

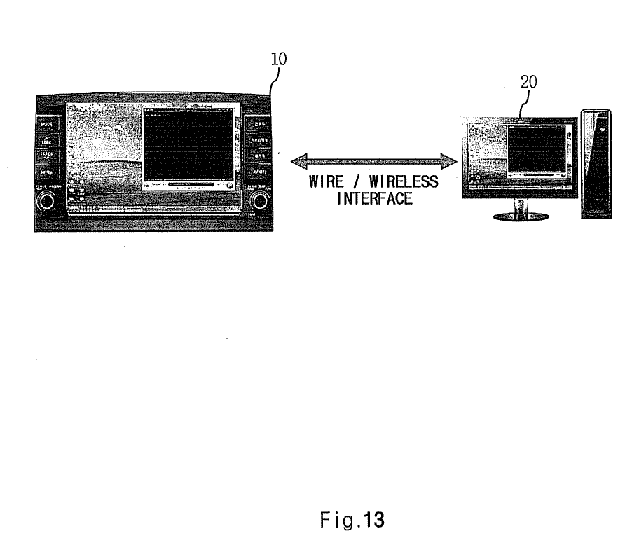

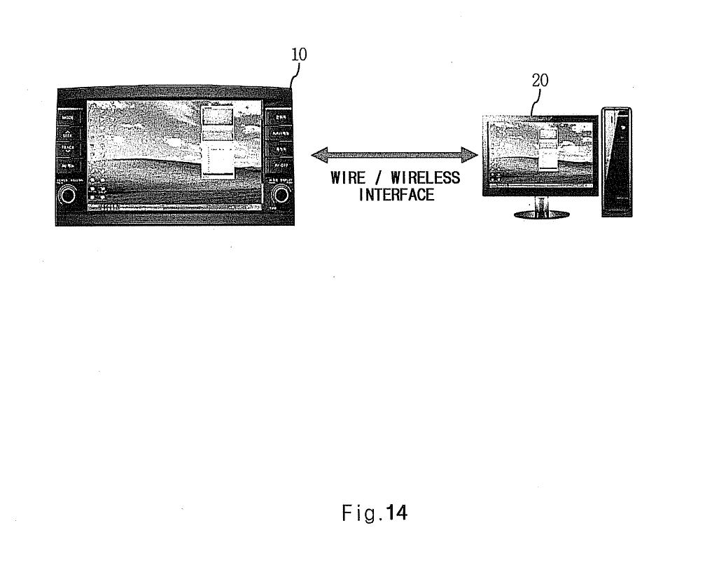

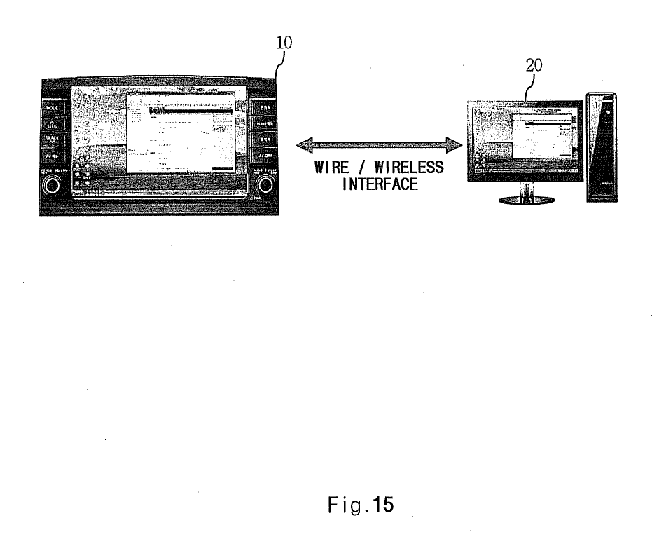

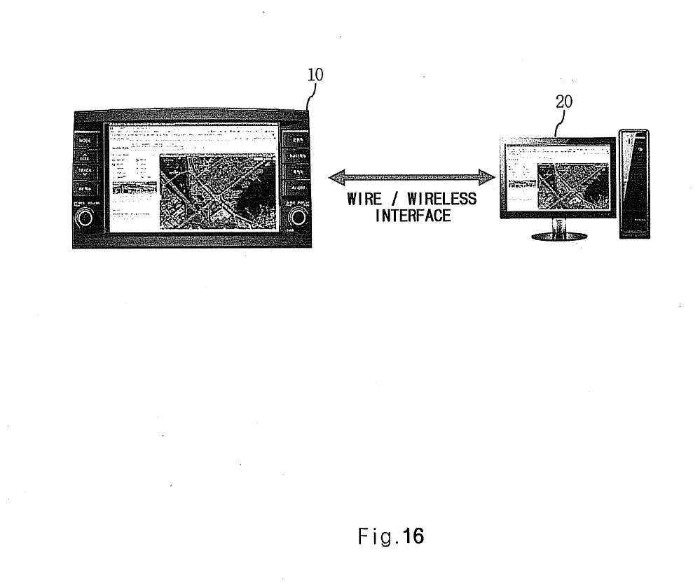

In another example, the first terminal 10 can be a typical personal computer and the second terminal 20 can be a head unit of the vehicle, and the connection terminal 30 is interposed between the first terminal 10 and the second terminal 20. If the personal computer and the connection terminal 30 are wired connected to each other and the connection terminal 30 and the head unit of the vehicle are wirelessly connected to each other, the head unit of the vehicle may remotely receive from the personal computer the execution information of the specific content such as, for example, a documentation program execution information (see FIG. 11), a web page execution information (see FIG. 12), a video program execution information (see FIG. 13), a messenger program execution information (see FIG. 14), an e-mail transmission program execution information (see FIG. 15) or a map data execution information (see FIG. 16) and transmit the event generation signal corresponding to the execution information of the received specific content to the personal computer so that the head unit of the vehicle can be used as the personal computer.

In still another example, the first terminal 10 can be a head unit of the vehicle and the second terminal can be a service providing server. In this case, the head unit of the vehicle analyzes vehicle information data collected based on the execution information of a vehicle control program (see also 17) and transmits the analyzed vehicle information data to the service providing server. The service providing server then generates and provides a content of an event that is associated with the vehicle information data (e.g., specific comments, instructions information) to the head unit of the vehicle.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A terminal having a content interworking function, the terminal comprising:
an execution module configured to execute a specific content to generate an execution information of the specific content;
a communication module configured to interwork with an external terminal to communicate a data therewith; and
a control module configured to transmit the execution information of the specific content to the external terminal such that the execution information of the specific content is displayed on a display module of the external terminal,
wherein the control module receives from the external terminal an event generation signal indicating a content of an event corresponding to the execution information of the specific content, the event being generated by a key input module of the external terminal.

2. The terminal according to claim 1, wherein the execution information of the specific content includes at least one of a vehicle information data, a vehicle diagnostic data, a multimedia reproduction information, a web page, a navigation program, a telephone calling program, an email program and a game.

3. The terminal according to claim 1, wherein the key input module includes a touch screen installed on the display module, and the content of the corresponding event includes at least one of information of a selection of a specific character, information of a selection of a specific image, a screen scroll signal that is included in the execution information of the specific content displayed on the display module, and an input signal of a specific text that is included in the execution information of the specific content displayed on the display module.

4. The terminal according to claim 1, further comprising a conversion module configured to convert the execution information of the executed specific content in accordance with a specification of the display module of the external terminal.

5. The terminal according to claim 1, wherein the external terminal interworks with the communication module via a separate communication terminal.

6. The terminal according to claim 1, wherein the terminal having the content interworking function is a multimedia terminal of a vehicle and the external terminal is a mobile communication terminal, a computer, or a service providing server.

7. The terminal according to claim 1, wherein the execution module includes,
a decoder configured to decode the specific content; and
an application program configured to execute the decoded specific content.

8. A method of interworking a content in a terminal, the method comprising:
(a) generating an execution information of a specific content by executing the specific content;
(b) transmitting the execution information of the specific content to an interlinked external terminal to display the execution information of the specific content on a display module of the external terminal; and
(c) controlling an execution operation of the specific content based on an event generation signal received from the external terminal, the event generation signal indicating a content of an event generated through a key input module of the external terminal.

9. The method according to claim 8, wherein the execution information of the specific content includes at least one of a multimedia reproduction information, a web page, a navigation program, and a game.

10. The method according to claim 8, wherein the content of the corresponding event includes at least one of a coordinate value of a specific character being touched, a coordinate value of an image being touched, a screen scroll signal text that is included in the execution information of the specific content displayed on the display module, and an input signal of a specific text that is included in the execution information of the specific content displayed on the display module.

11. The method according to claim 8, wherein the external terminal interworks with a communication module via a separate communication terminal.

12. The method according to claim 8, wherein the terminal is a multimedia terminal of a vehicle and the external terminal is a mobile communication terminal, a computer, or a service providing server.
